(19) United States
(12) Patent Application Publication
(10) Pub. No.: US 2003/0081004 A1
(43) Pub. Date: May 1, 2003

(54) System and method for creating mass customized graphic designs

(75) Inventor: Thomas A. Liguori, Poway, CA (US)

Correspondence Address: Mr. Richard H. Zaitlen, PILLSBURY WINTHROP LLP, 725 South Figueroa Street, Suite 2800, Los Angeles, CA, 90017, US

(73) Assignee: TLCD Ltd.

(21) Appl. No.: 10/001,655

(22) Filed: Oct. 31, 2001

(51) Int. Cl. G09G 5/00

(52) U.S. Cl. 345/764

(57) ABSTRACT

An apparatus and method for providing graphic samples of mass customized graphic designs on objects, in either real or virtual form that includes software allowing a user to capture and record keystrokes. The invention operates by incorporating a communications link that includes a public communications network, such as the Internet, along with an electronically coupled user computer and a central computer for proactively merging, manipulating and compiling images to produce output data in the form of virtual items associated with distributed items.

### BACKGROUND

1. Field of the Invention

This invention relates to a method and a system for creating mass customized graphic designs in either virtual form, such as web pages or emailed virtual samples, or in real form such as printed paper or products.

2. Related Art

It is known in the art generally that the presentation of customized materials and graphics to individuals is an effective way of increasing attention, interest and often sales. For example, customized letters and emails often attract more attention than those that are not customized. Typically, such samples will be created by laser engraving or printing single color silk screen images on products. However, while such samples do attract more attention than non-personalized samples, they are normally very plain and, therefore, provide a far less dramatic presentation than a four color process image. It is clear that the more colorful, personalized and customized an item is, the more attractive it is to its recipient.

Therefore, there is a need for a method and system that provides a versatile imaging process which provides a dramatically more interesting sample, in either real or virtual form, to a recipient. The power of these improved graphic samples results in greater attention to the advertisement and, in some cases, higher response rates and improved profitability.

### BRIEF DESCRIPTION OF THE DRAWINGS

A detailed description of embodiments of the invention will be made with reference to the accompanying drawings, wherein like numerals designate corresponding parts in the several figures.

FIG. 1 is a block diagram illustrating a system for providing graphic samples of self-created images on objects.

FIG. 2 is a flowchart depicting a series of actions that may be taken and decisions that may be made by a customer or prospective customer attempting to initiate access to a virtual item in an embodiment of the present invention.

### DETAILED DESCRIPTION

In the present invention, an individual can create a physical sample that can be distributed to customers or prospective customers and/or an electronic, virtual sample that can be distributed to customers or prospective customers via a communications network. The term “distributed item” shall be used to describe the former while the terms “virtual item” or “web page” shall be used to describe the latter. Hereinafter, an embodiment of the invention specifically involving writing instruments will be described in further detail. In describing this embodiment of the invention, the terms “distributed writing instrument” and “virtual writing instrument” will be used in the same way that the terms “distributed item” and “virtual item” may be used for a broader description of the invention.

Although an embodiment focusing on writing instruments is mainly described herein, it will be readily evident to a person of ordinary skill in the art that the invention described herein can be equally applicable to writing instruments of all shapes, sizes, formats, mediums and compositions and promotional items and collectibles such as plaques, plates, trophies, pins, medallions, cels, figurines, steins, tankards, mugs, cups, coins, dolls and other such items as well as any other item that can be printed with four color custom imagery. The invention described herein is also applicable to custom designed web pages, electronic mail and all other formats that allow imagery to be transmitted over the Internet.

The present invention allows for printing individually created images on objects through a communications link which includes a public communications network, such as the Internet, at least a first computer for use by a user and at least one central computer or server for managing, manipulating and compiling the images. It should be appreciated that as described herein, a user refers to a customer or prospective customer using the invention disclosed herein. Such a user is often “passively” receiving customized materials and graphics as opposed to “proactively” seeking out and selecting samples.

Among the several objects of the present invention may be noted the provision of a versatile printing apparatus and process to be used in conjunction with the invention disclosed herein, which will give the customer or prospective customer a dramatically more interesting sample in either real or virtual form. The invention improves the ability of a supplier to provide its user's/customer's with a customized, personalized sample of the customer's order. Additionally, according to the invention the keystrokes used to create unique artwork are captured and applied to a database of customers and prospective customers to create a dynamic file of thousands of graphic images, which can be fed into the invention to produce physical samples and/or virtual samples in the form of web pages or electronic mail.

Embodiments of the invention in which a distributed item is paired with a virtual item displayed in the form of a writing instrument are described. However, it will be apparent to a person of ordinary skill in the art that a distributed item may be paired with other virtual items such as those described above.

Generally, according to the present invention, a virtual item is created through a mass customization process in which user information is input to the system and the virtual item is output. Information associated with the image (e.g., size, colors, clarity, density, the image itself, etc.) is managed, manipulated, calculated and compiled at the central computer to produce an output image displayed on a virtual item. This output image may be archived in storage to be accessed at a later time. Next, a user receives a particular identifier associated with and specific to a particular virtual item. Thereafter, the user may access the virtual item at a centralized computer or computer “farm,” controlled by a supplier, through a communications network. If the user chooses, the user may utilize a remote terminal to input information associated with the image to be created and to transmit the information from the remote computer terminal to the central computer through the public communications network. Next, the output image displayed on a virtual item is transmitted from the central computer back to the remote user computer through the public communications network, and displayed at the remote computer terminal. If desired, the user can modify the output image displayed on a virtual item, causing the information associated with the image to be recalculated. The final output image displayed on a virtual item is stored on the central computer. Subsequently, when a user decides to order a distributed writing instrument, the supplier utilizes the centralized computer system to either retrieve the archived output image displayed on a virtual item or dynamically recreate the same. The output image may also be sent to a printing apparatus, such as the Print Product on Demand, disclosed in U.S. Pat. No. 6,151,130 to Liguori, et al., where one or more distributed writing instruments may be produced.

In particular embodiments of the present invention, the calculated image information is stored on the central computer, but is only accessible by the user via the user's particular identifier paired with a specific virtual item(s). Subsequently, when the user decides to order a distributed writing instrument associated with the output image displayed on a virtual writing instrument, the user retrieves the virtual writing instrument stored on the central computer to place the order.

It should be appreciated that the centralized computer 20 can be a “farm” of computers, coupled or connected to each other as well as an archiving storage system. In such an instance, the “farm” of centralized computers operates synchronously or simultaneously to process file information quickly and efficiently and provides output data to the archiving storage system. Accordingly, for purposes of simplicity and clarity, herein is described a central computer in the singular sense. That is, the computer is not referred to as a multi-station system but rather a single system comprised of multiple parts.

Additionally, the mass customization described herein, whereby a virtually unlimited amount of input data can be processed to provide the resultant output data is an important feature of the present invention. Moreover, the method of creating output data proactively and sending such output data to users (customer's and potential customer's) who react to the design by either accepting or modifying it is a novel aspect of the present invention. That is, in known systems, the seller must wait for a user or customer to visit its website and then react to the user's request (seller is reactive, user is proactive). Such systems are completely inapposite and fundamentally contrary to the method of the present invention wherein the seller is proactive and the user is reactive.

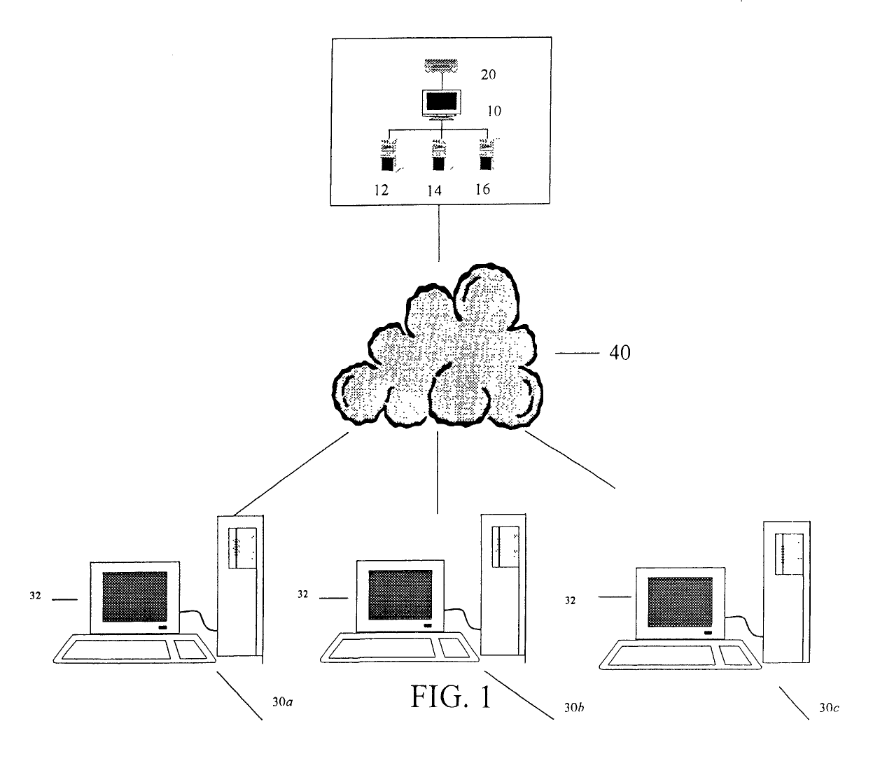

One arrangement for achieving the objects of the present invention is illustrated in FIG. 1. The illustrated system includes an art creation center 10 where digital graphic data representing an artistic design is created. The art creation center may include, without limitation, a computer 12, at least one digital image processing graphic arts program (“GAP”) 14 and at least one digital input capture technology program (“DICT program”) 16. The seller creates a design using one or more GAPs 14. Once the design is approved, the seller duplicates the design. However, upon duplicating the design, the input data used to open and start the GAP 14 and those used to produce the design is captured and saved using the DICT program 16. Once the DICT program 16 has captured and saved the input data, file information (e.g., customer names, prospective customer names or any sort of data which one wishes to print onto the graphic or virtual sample) is loaded into the DICT program 16 for processing. File information may be supplied by either the seller at the central computer 20 or uploaded to the central computer 20 by the user. A parallel processing is applied in which the DICT program 16, operating within, alongside, invisibly within or simultaneously with the GAP 16 captures a first file information and applies the saved input data from the DICT program 16, within the GAP 14, to the file information. The applied parallel processing produces output data comprised of the first file information, graphically rendered in the design created using the GAP 14, to produce an output image displayed on a virtual writing instrument. Once the first file information is rendered as a graphically designed output image on a virtual writing instrument, the DICT program 16 continues on to a second file information. If desired, the system repeats the process to produce a second output image on a virtual writing instrument comprised of a second file information rendered as a graphically designed output image on a second virtual writing instrument, in the design created in the GAP 14. The process is continued until the desired amount of file information is rendered as graphically designed output images on virtual writing instruments in the designs created using the GAP 14.

Alternatively, as described in more detail below, the user could access the art creation center 10 directly. That is, the user could operate the GAP and DICT programs as if the user were present at the seller side central computer.

The DICT program effectively acts as a perpetual loop, provided that file information continues to be fed into the DICT program. Moreover, because the output of the process is an image displayed on a virtual writing instrument displayed on a web page, each output image displayed on a virtual writing instrument can either be archived for later display upon user access or created dynamically at the time that a customer accesses the seller's website. As discussed below, user access and dynamic web page construction (or storage archive retrieval) is effected by the use of an identifier that is unique to a particular customer and associated with a particular virtual item. That is, comporting with the discussion above regarding the proactive nature of the present invention, the user does not have to input file information upon accessing the seller's website in order to begin the process of producing an output image. Rather, in the present invention, the output image corresponding to a particular user, which is displayed on a virtual writing instrument, is created as described above and then stored at the central computer 20. Thereafter, when the user accesses the seller's website, the virtual writing instrument is either received from storage or dynamically constructed on the web page being viewed by the user through the operation of the GAP and DICT, which recorded the keystrokes of the image therein, as described above.

A suitable GAP program would be PhotoShop®, Corel Draw®, Photdraw®, Freehand®, Fireworks® or any other graphic design program. Using the GAP program, a user can create a design that can be used and applied to a virtual, and, eventually, a distributed writing instrument.

A suitable DICT program would be Automate® or any other program that allows one to record keystrokes so that a proper output image is created without the constant monitoring and supervision of an operator.

Continuing to refer to FIG. 1, the image management system includes one or more user computers 30. Each user computer includes memory (such as RAM and ROM) (not shown) and at least one processor (not shown) for executing applications. Each user computer 30 also includes an input device (such as a keyboard, a mouse or other pointing device, and/or the like) (not shown) and an output device (such as a display or the like) 32. Each user computer 30 further includes communications equipment for connecting to the Internet 40. Each user computer 30 also includes a modem for connecting to the Internet 40. An image owner using the user computer 30 may obtain access to the Internet 40 using an online services network (such as America Online®, CompuServe®, Microsoft Network®, Prodigy®, or the like) or by establishing an account with an Internet Service Provider (ISP). In alternative embodiments, each user computer 30 may include other equipment for connecting to the Internet 40, such as a network card or the like, and may connect to the Internet 40 via other connections, such as a private enterprise network (e.g., LAN) that includes at least one server connected to the Internet or the like.

The image management system further includes one or more central computers (“web server”) 20, connected to the Internet 40 through a firewall (not shown). The web server 20 includes memory (such as RAM, ROM, and a hard disk) (not shown) and at least one processor (not shown) for executing applications. The web server 20 is connected to the Internet 40 either directly or via a network, such as a local area network (“LAN”), a wide area network (“WAN”) or the like. The web server 20 includes one or more server applications, each of which is comprised of one or more program files stored in the memory of the web server 20 and which operates in conjunction with a corresponding client application executing on the user computer 30. The web server is also connected to an archival storage system (not shown) in which output data from the web server is stored for access by a user as discussed in more detail below.

Continuing to refer to FIG. 1, the operational environment for the method and the basic components of the present invention is illustrated. The communications link includes a public communications network. The public communications network is a worldwide system of networks commonly known as the Internet 40. The communications link is connected to, and serves as a medium of communication among, one or more remote computer terminals 30a, 30b and/or 30c for use by one or more users (“user computer”) and a central computer 20 for managing, manipulating and compiling the individually created images. The communications link includes the Internet 40 as well as equipment for electronically connecting the user computers 30 and the central computer 20 in a manner well known to those skilled in the art. In alternative embodiments, the communications link may include any other public or hybrid public-private communications network that transfers data packets among computers or nodes in the network.

In summary, the illustrated system includes an art creation center 10 that is linked to a central computer 20, which, in turn, is linked to the Internet 40. The communications network may be a public network, e.g., the Internet, a private network, e.g., a local area network (LAN), wide area network (WAN), metropolitan area network (MAN), a leased line network or a combination thereof The communications network may be implemented as a wire-line system using telephone twisted-pair lines, coaxial cable lines, fiber optic lines, or the like, or as a cellular, satellite or other wireless system using microwave, infrared, radio or other frequency transmission. The art creation center 10 includes, among other things, a digital processing system 12 on which the GAP 14 and DICT program 16 operate. The output data generated within the art creation center is stored on the central computer 20. In one embodiment, the output data, comprising an output image displayed on a virtual writing instrument, is digitally transferred by, for example, an email program, across the communications network (Internet) 40 to a remote computer 30. Next, a user at the remote computer 30 opens the digitally transferred output data using the appropriate mouse clicks or keystrokes. Then, the output data displayed on a virtual writing instrument, which was created at the art creation center 10, is opened and can be viewed by a user on a display 32 at a remote computer 30 in the form of an output image displayed on a virtual writing instrument.

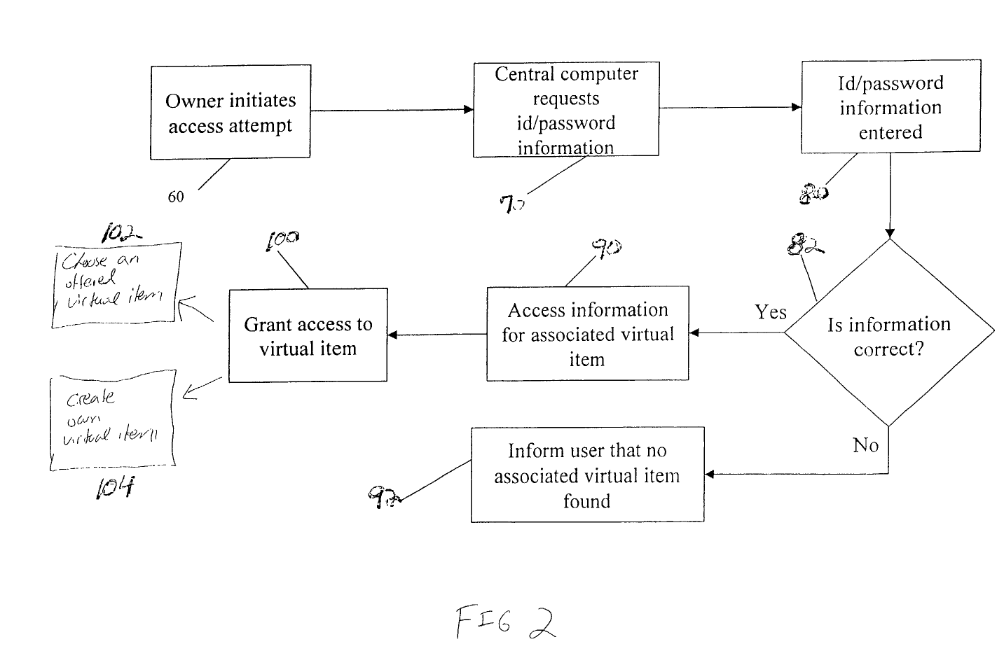

Referring to FIG. 2, output data consisting of an identifier associated with a particular virtual item is transmitted by, for example, an email program, across the communications network to a remote computer. It should be appreciated that the identifier may also be distributed in hard copy format via the United States Postal Service, Federal Express, United Parcel Service or other similar or suitable document delivery services. It should be further appreciated that the identifier can be delivered through alternative electronic delivery services, such as facsimile or the like.

Not shown is the process of mass customization, which is one of the objects of the present invention. Specifically, a database of file information is supplied to the web server. The web server processes this information as quickly as possible and sends the output data to an archiving storage system. The web server then sends out a unique identifier to the user in order for the user to access the archived output data. This process is accomplished as follows.

The user accesses the supplier web site in step 60. Next, the central computer 20 requests the users' identifier in step 70. Upon entering and submitting the identifier at a seller's website in step 80, which is controlled by the central computer 20, the central computer 20 confirms that the identifier is correct and associated with a particular virtual item in step 82. If the identifier has an associated virtual item, the central computer 20 accesses the associated virtual item in step 90. The user is then linked to a personalized web page in step 100. The personalized web page may be a customized web page offering certain personalized graphics—allowing the user to manipulate, choose and format the graphics if he or she chooses. The personalized web page may also be a web page on which at least one virtual writing instrument associated with the identifier is displayed for the user to choose from in step 102. The user can edit the virtual writing instrument displayed on the customized web page in order to fit the user's desires and/or needs in step 104.

If the user does not see a virtual item to order, the user may edit an existing virtual item, or alternatively, design and create a new design to be displayed on a virtual writing instrument. In this embodiment, the user can create a unique self-created design by uploading graphics, adding text to the design, etc. Once complete the user receives the self-created design displayed on a virtual item, which can be submitted to the host central computer 20 controlled by the supplier for production of distributed items. In this embodiment, a user utilizes a first user computer/computer terminal 30 to input information associated with an image and to transmit the information associated with an image from the user computer 30 to a central computer 20 through the public communications network (Internet) 40. Information associated with the image is calculated, manipulated, managed and compiled at the central computer 20, transmitted from the central computer 20 through the public communications network 40 and displayed at the user computer 30 in the form of an image output displayed on a virtual writing instrument. The user can modify the image displayed on a virtual writing instrument as desired. The final output image displayed on a virtual writing instrument is stored at the central computer 20.

In the process of causing a terminal to display a virtual writing instrument, the art creation center may access a database containing information associated with various virtual writing instrument samples. The virtual image may be stored in computer readable files in Portable Document Format (PDF), Moving Pictures Experts Group format (MPEG), Joint Photographic Experts Group format (JPEG), Graphics Interchange Format (GIF) or any other format suitable for image data files. The names or addresses of files containing thumbnail images, grayed out images and images of the evolved virtual writing instrument may also be stored.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than by the foregoing description, and all changes that come within the meaning and range of equivalency of the claims are therefore intended to be embraced therein.

What is claimed is:

1. A method for creating and distributing mass customized image, the method comprising the steps of:
providing a central computer including:
(a) a display device
(b) a central processing unit
(c) an input device
creating virtual items through mass input of file information into an executable file operating on the central computer to provide output data;
distributing from the central computer to a user at the remote computer an identifier associated with the virtual item;
receiving at the central computer, from said user at the remote computer, information related to said identifier;
automatically confirming the user and said virtual item based on said identifier; and
causing said virtual item to be displayed to said user at the remote computer.

2. The method of claim 1, wherein the identifier is distributed via a delivery service.

3. The method of claim 1, wherein the identifier is distributed electronically.

4. The method of claim 1, wherein the identifier causes the central computer to automatically retrieve said virtual item from a storage medium associated with the central computer

5. The method of claim 1, wherein the identifier causes the central computer to dynamically construct said virtual item, as created through mass input of file information, at the time the user accesses the central computer.

6. The method of claim 1, wherein the virtual item is distributed directly from the central computer to a web page to be accessed by the user.

7. The method of claim 1, wherein the virtual item is distributed directly from the central computer to a printing apparatus to facilitate creating a distributed item, whereby the distributed item may be sent to user.

8. The method of claim 1, wherein the virtual item is created by an operator applying input data within a graphic arts program to create an image design from image data to be applied to a virtual item and a digital input capture technology program is executed at the central computer to capture input data used to create the image data.

9. The method of claim 8, wherein the digital input capture technology program is executed simultaneously with the graphic arts program.

10. The method of claim 1 wherein said user may apply file information to the virtual item utilizing the graphic arts program in order to create a distributed item.

11. An apparatus for printing individually created images on objects, the system comprising:
at least one remote computer, the remote computer being coupled to a central computer through a communications link, said communications link including a public communications network;
a digital image processing graphic arts programs;
a digital input capture technology programs; and
file information.

12. A system for creating images on items, the system comprising:
a central computer;
a remote computer;
means for generating at least one digital image;
means for transferring information about said digital image over a communications network;
means for altering the at least one digital image; and
means for at least one digital image on a virtual item in response to a request.

13. A method for creating images on objects using a remote computer, the remote computer being coupled to a central computer through a communications link which includes a public communications network, the method comprising the steps of:
inputting data representative of information associated with an image at the remote computer;
transmitting the information from the remote computer to the central computer through the public communications network.
managing the information associated with the image;
transmitting the managed information from the central computer to the remote computer through the public communications network; and
displaying the information in the form of an image.

14. A method for printing self-created images on objects, the method comprising the steps of
providing a central computer;
proving a remote computer;
providing an art creation center for creating design images, said art creation center including:
(a) a graphic arts program;
(b) a digital input capture technology program;
(c) a computer, wherein the graphic arts program and the digital input capture technology program execute simultaneously on the computer;
providing file information;
generating output data from the file information in the form of a design image created using the art creation center;
generating a unique identifier associated with the file information in the form of a design image;
transmitting, over the Internet, the unique identifier associated with the file information in the form of a design image to the remote computer;
using the remote computer, electronically coupled to the Internet, to access the unique identifier;
using the remote computer to access the central computer over the Internet;
inputting the identifier at the central computer;
dynamically constructing and displaying at the remote computer, the design image associated with the unique identifier.

15. The method of claim 14, wherein a user at the remote computer selects the design image to be transmitted to a printing apparatus for producing a distributed item.
